(19) United States
(12) Patent Application Publication
(10) Pub. No.: US 2022/0056222 A1
(43) Pub. Date: Feb. 24, 2022

(54) MULTI(METH)ACRYLATE-FUNCTIONALIZED RESINS AS CO-AGENTS FOR CROSSLINKING OF THERMOPLASTIC POLYMERS

(71) Applicant: Arkema France, Colombes (FR)

(72) Inventors: Michael A. Bailey, King of Prussia, PA (US); Jeffrey Klang, King of Prusssia, PA (US); Mahendra C. Orilall, King of Prussia, PA (US); Zackariah J. Weinert, King of Prussia, PA (US); Weijin Lu, King of Prussia, PA (US)

(21) Appl. No.: 17/414,432

(22) PCT Filed: Dec. 16, 2019
(86) PCT No.: PCT/IB2019/001396

§ 371 Date: Jun. 16, 2021

Related U.S. Application Data
(60) Provisional application No. 62/780,410, filed on Dec. 17, 2018.

(51) Int. Cl. C08J 3/22; C08J 5/18; C08J 3/28; C08K 5/13; B29B 9/06

(52) U.S. Cl. CPC C08J 3/226; C08J 5/18; C08J 3/28; C08J 2435/02; B29B 9/065; C08J 2323/06; C08K 5/13

(57) ABSTRACT

Polymer compositions capable of being crosslinked, for example by ionizing radiation such as electron beam radiation, are prepared from masterbatch compositions containing thermoplastic polymer, multi(meth)acrylate-functionalized resin, and, optionally, scorch retarder (which is preferably present if the multi(meth)acrylate-functionalized resin has a low (meth)acrylate equivalent weight). Such polymer compositions are useful for the manufacture of articles such as films, fibers and the like.

### FIELD OF THE INVENTION

The present invention relates to the crosslinking of thermoplastic polymers using co-agents, masterbatch compositions containing thermoplastic polymers and co-agents, and crosslinked articles such as films which are prepared from such compositions.

### BACKGROUND OF THE RELATED ART

The use of various (meth)acrylate-functionalized compounds as co-agents in the crosslinking of thermoplastic polymer films, fibers and the like to enhance or modify the performance properties of such articles is known in the art, wherein the polymer is crosslinked using thermal (heat) initiation of peroxides or radiation initiation (e.g., by UV, using a photoinitiator, or by high energy radiation such as electron beam radiation). The following patent documents are illustrative of this technology.

U.S. Pat. No. 9,040,601 describes compositions comprising a propylene-based polymer with a low level of diene-derived units; an antioxidant; and a co-agent (such as liquid and metallic multifunctional acrylates and methacrylates, including pentaerythritol tetramethacrylate, ethylene glycol dimethacrylate and trimethylolpropane trimethacrylate). The compositions can be at least partially crosslinked by electron beam radiation and formed into articles such as fibers, yarns, films and non-wovens.

U.S. Pat. No. 8,916,647 describes crosslinked polymeric films, laminates, membranes and other polymeric articles, which may be formed using compositions comprising various types of olefin-based polymers (including propylene/ethylene interpolymers), wherein the composition is crosslinked using radiation and/or chemicals. The compositions may additionally comprise one or more additives such as antioxidants.

U.S. Pat. No. 8,765,832 discloses compositions comprising at least one propylene-based polymer; at least one multifunctional acrylate, multifunctional methacrylate, functionalized polybutadiene resin, functionalized cyanurate or allyl isocyanurate; a hindered phenol, phosphite, or hindered amine; and a photoinitiator for UV curing. The composition can be extruded and crosslinked, to make films and fibers.

U.S. Pat. Nos. 8,742,019 and 8,765,834 disclose crosslinked polyolefin blends of multiple polyolefins, which may be compounded with one or more co-agents, antioxidants, UV sensitizers and/or other additives and crosslinked by exposure to UV radiation and/or energetic photons to provide fibers, films and nonwovens. Suitable co-agents are said to include liquid and metallic multifunctional acrylates and methacrylates such as pentaerythritol tetramethacrylate, trimethylolpropane trimethacrylate and ethylene glycol dimethacrylate.

U.S. Pat. No. 8,431,065 describes methods of making elastomeric compositions which include a polypropylene polymer, a trifunctional co-agent and a co-agent that can be crosslinked with electron beam radiation to enhance the properties of films and fibers prepared from the elastomeric compositions.

U.S. Pat. No. 7,867,433 discloses an elastomeric composition comprising at least one propylene-based polymer which is blended with at least one component selected from the group consisting of multifunctional acrylates, multifunctional methacrylates, functionalized polybutadiene resins, functionalized cyanurate, and allyl isocyanurate and with at least one component selected from the group consisting of hindered phenols, phosphites, and hindered amines. Articles formed from these blends, such as films, can be crosslinked using electron beam radiation.

Chinese Published Patent Application CN 103709473 discloses a resin composition comprising: thermoplastic resin; polyfunctional resin; photoinitiator; polyfunctional monomer; and stabilizer. The thermoplastic resin can be a polyolefin. The polyfunctional resin can be a urethane acrylate oligomer, a polyester acrylate oligomer, or an epoxy acrylate oligomer.

U.S. Pat. No. 5,795,941 discloses crosslinkable bimodal polyolefin compositions. According to this document, use may be made of a combination of an electron beam and a crosslinking activator or multifunctional monomer (e.g., pentaerythritol tetraacrylate) in order to successfully crosslink the polyolefin composition. A heat stabilizer or radiation stabilizer may also be present in the composition.

### SUMMARY OF THE INVENTION

Aspects of the present invention relate to the addition of certain types of multi(meth)acrylate-functionalized resins as co-curing agents (“co-agents”) to enhance the ultraviolet (UV)-, UV-LED-, or ionizing (e.g., electron beam) radiation-induced crosslinking (curing) of thermoplastic polymers and improve the properties of articles (in particular, films) fabricated therefrom. When the multi(meth)acrylate-functionalized resins are relatively low in (meth)acrylate equivalent weight (e.g., a (meth)acrylate equivalent weight of less than 500 daltons), the thermoplastic polymers are further combined with high loadings of scorch retarder to prevent premature polymerization or degradation of the multi(meth)acrylate-functionalized resin co-agents during the compounding process. (Meth)acrylate equivalent weight is calculated by dividing the number average molecular weight of the multi(meth)acrylate-functionalized resin by the number of (meth)acrylate functional groups per molecule. The present invention provides an improved ability to consistently obtain higher performance properties in the crosslinked article (e.g., film), such as better tear, impact and heat resistance, as a result of the presence of the multi(meth)acrylate-functionalized resin, as compared to what is achievable by radiation curing alone in the absence of such co-agents.

Additionally, the present invention provides for a polymer/co-agent masterbatch composition which may be prepared by compounding a high concentration of a multi(meth)acrylate-functionalized resin co-agent (in particular, a co-agent or a combination of co-agents which is liquid at 25° C.) into a thermoplastic polymer and converting the resulting blend into solid, dry and non-blocking pellet form. To prevent or reduce reaction of the multi(meth)acrylate-functionalized resin co-agent during such compounding, especially when the compounding is performed at a relatively high temperature or when the multi(meth)acrylate-functionalized resin is particularly susceptible to degradation during compounding, one or more scorch retarders are preferably also present. Such a concentrated masterbatch i) eliminates the need for producers of crosslinked articles (such as crosslinked films) to retrofit existing extrusion equipment with liquid injection delivery systems; ii) greatly reduces possible worker exposure to liquid co-agents; and iii) improves the consistency of co-agent loading in the final thermoplastic polymer composition. Preferred processes to prepare such concentrated thermoplastic polymer/co-agent masterbatch compositions include: 1) twin-screw extrusion with the use of liquid injection delivery equipment such as either a positive pressure diaphragm pump, a peristaltic pump or a progressive cavity pump, equipped with a strand die and an underwater pelletizer and 2) a continuous mixer in-line with a single screw extruder, equipped with a strand die and an underwater pelletizer.

### DESCRIPTION OF THE DRAWINGS

FIG. 1 is a plot of electron beam-coagent cure effect on Energy at Break versus electron beam dose, as explained in more detail in the Examples.

FIG. 2 shows the effect of (meth)acrylate co-agent addition on Tear Resistance of electron beam-crosslinked LLDPE, as explained in more detail in the Examples.

FIG. 3 shows the effect of (meth)acrylate co-agent addition on Impact Resistance of electron beam-crosslinked LLDPE, as explained in more detail in the Examples.

FIG. 4 shows the effect of (meth)acrylate co-agent addition on Heat Resistance and Dynamic Modulus of electron beam-crosslinked LLDPE by DMA Analysis, as explained in more detail in the Examples.

### DETAILED DESCRIPTION OF CERTAIN EMBODIMENTS OF THE INVENTION

### Thermoplastic Polymers

As previously mentioned, the present invention relates to the use of certain types of multi(meth)acrylate-functionalized resins as co-agents in the crosslinking of polymers, especially thermoplastic polymers, in particular nonpolar and/or non-elastomeric polymers such as nonpolar, non-elastomeric thermoplastic polymers (e.g., polyolefins, especially polyethylenes). The properties and characteristics of polymers may be modified through such crosslinking. Examples of suitable polyolefins include ethylene homopolymers, copolymers of ethylene with one or more other olefins, homopolymers of propylene, and copolymers of propylene and one or more other olefin polymers. For example, the polyolefin to be crosslinked using the multi(meth)acrylate-functionalized resin may be low density polyethylene (LDPE), linear low density polyethylene (LLDPE), high density polyethylene (HDPE), metallocene polyolefin polymer (POP), ethylene vinyl acetate (EVA), ethylene vinyl alcohol (EVOH), and polyamides, and combinations thereof. In preferred embodiments, the polyolefin to be crosslinked using the multi(meth)acrylate-functionalized resin LDPE or a blend of EVA & LDPE. According to certain embodiments of the invention, the thermoplastic polymer is non-elastomeric. As used herein, the term “non-elastomeric thermoplastic polymer” means a thermoplastic polymer that does not display rubber-like elasticity (i.e., a thermoplastic polymer that is not able to resume its original shape when a deforming force applied at 25° C. to the thermoplastic polymer is removed).

However, elastomers (rubbers) may also be crosslinked using the multi(meth)acrylate-functionalized resins described herein. Examples of such rubbers and elastomers include, but are not limited to, polyolefinic elastomers (POE), ethylene propylene diene rubbers (EPDM), polyisobutylene, diene-based rubbers such as polybutadiene, polyisoprene, copolymers of butadienes and one or more other monomers (such as styrene), and copolymers of isoprene and one or more other monomers. Other types of polymers in which the multi(meth)acrylate-functionalized resins may be used as co-agents include ethylene vinyl acetate copolymers, ethylene alkyl (meth)acrylate copolymers and polyamides.

According to certain embodiments, the thermoplastic polymer to be crosslinked is fully saturated or essentially fully saturated. For example, the thermoplastic polymer may have a total amount of carbon-carbon double bonds per 1000 carbon atoms of less than 0.1, less than 0.05 or even 0.

The thermoplastic polymer in the masterbatch composition functions as a carrier polymer for the multi(meth)acrylate-functionalized resin and optional scorch retarder components of the masterbatch composition, as well as any other additives which may form part of the masterbatch composition. The thermoplastic polymer used to prepare masterbatch compositions in accordance with the present invention may be any of the above-mentioned types of thermoplastic polymers or a blend of two or more such polymers. The multi(meth)acrylate-functionalized resin(s) as well as the scorch retarder(s), if present, is/are dispersed, preferably in a homogeneous manner, in the carrier polymer component of the masterbatch composition, which helps to ensure that when the masterbatch composition is subsequently used to prepare a polymer composition by mixing with a second thermoplastic polymer (which preferably is the same type of thermoplastic polymer as the thermoplastic polymer of the masterbatch composition, but which contains little or no multi(meth)acrylate-functionalized resin) the multi(meth)acrylate-functionalized resin(s), optional scorch retarder(s) and optional other additives become well-dispersed in the resulting polymer composition.

Typically, the thermoplastic polymer is the predominant component by weight of the masterbatch composition, with smaller amounts of multi(meth)acrylate-functionalized resin, optional scorch retarder, and, optionally, one or more other additives also being present. The multi(meth)acrylate-functionalized resin may be present in an amount of at least about 5%, preferably at least about 10%, or at least about 15%. (Unless indicated otherwise, all percentages herein are given in weight percent based on the total weight of the masterbatch.) The multi(meth)acrylate-functionalized resin may be present in an amount of at most 40%, at most about 35%, or at most about 30% based on the total weight of the masterbatch composition. Additionally, the masterbatch composition may comprise at least 60%, at least 65%, or at least 70%, and at most 85%, at most 90%, at least 85%, or at most 90% by weight of thermoplastic polymer, based on the total weight of the masterbatch.

### Multi(Meth)Acrylate-Functionalized Resins

The masterbatch compositions of the present invention are formulated to contain a relatively high loading of multi(meth)acrylate-functionalized resin (which may be a single multi(meth)acrylate-functionalized resin or a combination of two or more multi(meth)acrylate-functionalized resins). Generally speaking, a multi(meth)acrylate-functionalized resin is an organic compound containing two or more (meth)acrylate functional groups per molecule. As used here, “(meth)acrylate” includes both acrylate and methacrylate functional groups. In certain embodiments, multi(meth)acrylate-functionalized resins are employed which meet one or both of the following criteria: i) at least five (meth)acrylate functional groups per molecule; and/or ii) a number average molecular weight of at least 500 daltons (wherein the number average molecular weight is the actual molecular weight as calculated from the empirical formula, in the case where the multi(meth)acrylate-functionalized resin is a discrete chemical compound, or the number average molecular weight as measured using gel permeation chromatography and polystyrene calibration standards, in the case where the multi(meth)acrylate-functionalized resin is oligomeric in structure and constitutes a mixture of individual oligomers of different molecular weight). It is also possible for the masterbatch composition to additionally contain one or more (meth)acrylate-functionalized resins that meet neither of these criteria, as will be explained in more detail subsequently.

The amount of multi(meth)acrylate-functionalized resin is at least 5% by weight based on the total weight of the masterbatch composition. For example, the masterbatch composition may comprise at least 10%, at least 15%, at least 20%, or at least 25%, and at most 30%, at most 35% or at most 40%, based on the total weight of the masterbatch composition, of multi(meth)acrylate-functionalized resin. At too high of a loading of multi(meth)acrylate-functionalized resin, however, separation between the multi(meth)acrylate-functionalized resin and the thermoplastic polymer serving as a carrier polymer may begin to occur. This may interfere with the ability to obtain pellets of masterbatch composition that are solid, dry and non-blocking and/or that have multi(meth)acrylate-functionalized resin well dispersed or homogeneously dispersed within the pellets.

For these reasons, the masterbatch carrier polymer can be a blend such as EVA and LDPE at 60% EVA and 40% LDPE; 65% EVA and 35% LDPE; 70% EVA and 30% LDPE; 80% EVA and 20% LDPE; and 90% EVA and 10% LDPE to allow a higher concentration of the multi (meth)acrylate functionalized resin without migration or blooming. According to certain embodiments, for example, the masterbatch composition may comprise not more than 40%, not more than 35%, or not more than 30%, and at least 25%, at least 20%, at least 15%, or at least 10%. by weight of multi(meth)acrylate-functionalized resin, in total, based on the total weight of the masterbatch composition. In one advantageous embodiment of the invention, the masterbatch composition is comprised of from 30% to 40% by weight of multi(meth)acrylate-functionalized resin, based on the total weight of the masterbatch composition.

Further, the addition of nanosilica at low levels to the masterbatch also allows a higher concentration of the multi (meth)acrylate functionalized resin without migration or blooming out of the compound. According to other certain embodiments, for example, the masterbatch composition may comprise not more than 15%, not more than 10%, not more than 5% and not more than 2% of nanosilica.

According to certain aspects of the invention, one or more multi(meth)acrylate-functionalized resins are used which correspond to Formula (I):

R(OC(═O)CR′═CH₂)ₓ (I)

wherein R is an organic moiety, R′ is —H or —CH₃, and x is an integer of 5 or more. In certain embodiments, x is 5 or 6 (i.e., the resin is a penta(meth)acrylate-functionalized resin or a hexa(meth)acrylate-functionalized resin, or a combination thereof). According to certain embodiments, R is a hydrocarbon moiety (that is, R does not contain any atoms other than carbon and hydrogen atoms). Such a multi(meth)acrylate-functionalized resin may be referred to as one having a hydrocarbon core structure. However, in other embodiments R contains one or more heteroatoms in addition to carbon atoms and hydrogen atoms. For example, R may contain one or more oxygen atoms, which may be present in the form of ester groups, ether groups, hydroxyl groups and the like. In certain embodiments, R is relatively low in molecular weight (e.g., less than 500 daltons), but in other embodiments R may have a higher molecular weight (e.g., at least 500 daltons, at least 750 daltons, at least 1000 daltons, at least 1500 daltons, or even higher). R may be aliphatic in certain embodiments of the invention, but it is also possible for R to contain one or more aromatic rings.

Generally speaking, such resins may be prepared by esterification of polyalcohols containing five or more hydroxyl groups per molecule with acrylic acid, methacrylic acid or a synthetic equivalent thereof (e.g., (meth)acrylic anhydride, (meth)acryloyl halides, or C1-C4 alkyl esters of (meth)acrylic acid). The polyalcohol may be partially or fully esterified; accordingly, one or more hydroxyl groups may remain, provided at least five (meth)acrylate groups have been introduced). Suitable polyalcohols include organic compounds containing five or more hydroxyl groups per molecule; preferably, the hydroxyl groups are primary and/or secondary hydroxyl groups. Examples of such polyalcohols include sugar alcohols such as arabitol, ribitol, xylitol, sorbitol, mannitol and dulcitol as well as other compounds such as dipentaerythritol and tripentaerythritol. Condensed oligomers of polyalcohols containing three or more hydroxyl groups per molecule may also be employed, such as triglycerol and tetraglycerol, provided such condensed oligomers have at least five hydroxyl groups per molecule. Alkoxylated derivatives of the aforementioned compounds are also suitable for use as the polyalcohol, wherein one or more of the hydroxyl groups of the base compound are reacted with one or more equivalents of an alkylene oxide such as ethylene oxide or propylene oxide or a mixture of such alkylene oxides. Longer chain alkylene oxides may be employed if it is desired to obtain a multi(meth)acrylate-functionalized resin that is more hydrophobic in character (which may help improve compatibility of the resin with nonpolar thermoplastic polymers such as polyolefins).

Specific examples of multi(meth)acrylate-functionalized resins in accordance with Formula (I) which are suitable for use in the present invention include, but are not limited to, dipentaerythritol penta(meth)acrylate; dipentaerythritol hexa(meth)acrylate; penta- and hexa(meth)acrylate esters of alkoxylated dipentaerythitol; (meth)acrylate esters of glycerol oligomers containing five or more acrylate and/or methacrylate groups per molecule; sorbitol penta(meth)acrylate; sorbitol hexa(meth)acrylate; six-mole propylene oxide, tri-methylol propane triacrylate; and (meth)acrylate esters of alkoxylated sorbitol containing five or more acrylate and/or methacrylate groups per molecule.

Also useful in the present invention are the multifunctional acrylated ether-ester products described in U.S. Pat. No. 9,682,916, the entire disclosure of which is incorporated by reference herein for all purposes. Such substances are the product of reaction of acrylic acid in deficit with a multifunctional polyol, which yields a mixture of acrylic multifunctional monomers and oligomers by simultaneous esterification and etherification reactions via Michael addition on the acrylate double bond of the excess hydroxyl groups borne by the acrylic esters obtained. The mean functionality of acrylate groups per mole of the product should be selected to be five or greater.

The multi(meth)acrylate-functionalized resin employed in the present invention could also be a compound in accordance with Formula (II):

(H₂C═CR¹—C(═O)O)ₙR²—OCH₂CHR³C(═O)O—R⁴(OC(═O)CR⁵═CH₂)_{b} (II)

wherein R¹, R³ and R⁵ are the same or different and are —H or CH₃, R² and R⁴ are the same or different and are each an organic moiety having a valency of a +1 or b+1 (preferably a hydrocarbyl moiety, such as C(CH₂)₄), a and b are the same or different and are integers of at least 1, and a+b is at least 2. In one embodiment, a+b is at least 5.

Such compounds may be prepared by the Michael addition of a compound in accordance with Formula (III) to a compound in accordance with Formula (W), as described for example in Japanese Patent Publication No. JP 2010-024380 (incorporated herein by reference in its entirety for all purposes):

(H₂C═CR¹—C(═O)O)ₐR²—OH (III)

CH₂═CR³C(═O)O—R⁴(OC(═O)CR⁵═CH₂)_{b} (IV)

Any of the multi(meth)acrylate-functionalized oligomers known in the art may also be used in the present invention, provided such oligomers contain two or more (meth)acrylate functional groups per molecule. The number average molecular weight of such oligomers may vary widely, e.g., from about 500 to about 50,000.

According to certain embodiments, the multi(meth)acrylate-functionalized resin is an oligomer having a number average molecular weight of 500 daltons or greater (e.g., 1000 daltons or greater) which has at least 2, at least 3, at least 4, at least 5 or at least 6 (meth)acrylate functional groups per molecule. Any of such oligomers known in the art may be used. Such oligomers may be based on highly branched (hyperbranched) base oligomers that are functionalized with (meth)acrylate groups using various different synthetic approaches.

Suitable multi(meth)acrylate-functionalized oligomers include, for example, polyester (meth)acrylate oligomers, epoxy (meth)acrylate oligomers, polyether (meth)acrylate oligomers, acrylic (meth)acrylate oligomers, polydiene (meth)acrylate oligomers, hydrogenated polydiene (meth)acrylate oligomers, polycarbonate (meth)acrylate oligomers and combinations thereof.

For example, a hydroxyl-functionalized highly branched polyether polyol or polyester polyol containing three or more hydroxyl groups per molecule may be prepared by methods known in the art and the hydroxyl groups then converted to (meth)acrylate groups by esterification (for example, by reaction with (meth)acrylic acid or a synthetic equivalent thereof). Not all the hydroxyl groups need to be converted, provided the degree of esterification is sufficient to achieve the desired (meth)acrylate functionality in the product. In the case of polyether polyols, such branching may be introduced, for example, by the use of a polyalcohol as a starter in an alkoxylation reaction wherein the polyalcohol contains three, four, five, six or more hydroxyl groups per molecule. It is also possible to utilize hydroxyl-functionalized alkylene oxides in a ring-opening polymerization reaction, perhaps in combination with one or more alkylene oxides that are not hydroxyl-functionalized, to provide hyperbranched polyether polyols.

Exemplary polyester (meth)acrylate oligomers include the reaction products of acrylic or methacrylic acid or mixtures thereof with hydroxyl group-terminated polyester polyols. The reaction process may be conducted such that all or essentially all of the hydroxyl groups of the polyester polyol have been (meth)acrylated, particularly in cases where the polyester polyol is difunctional. The polyester polyols can be made by polycondensation reactions of polyhydroxyl functional components (in particular, diols) and polycarboxylic acid functional compounds (in particular, dicarboxylic acids and anhydrides). The polyhydroxyl functional and polycarboxylic acid functional components can each have linear, branched, cycloaliphatic or aromatic structures and can be used individually or as mixtures.

Examples of suitable epoxy (meth)acrylate oligomers include the reaction products of acrylic or methacrylic acid or mixtures thereof with glycidyl ethers or esters.

Suitable polyether (meth)acrylate oligomers include, but are not limited to, the condensation reaction products of acrylic or methacrylic acid or mixtures thereof with polyetherols which are polyether polyols (such as polyethylene glycol, polypropylene glycol or polytetramethylene glycol). Suitable polyetherols can be linear or branched substances containing ether bonds and terminal hydroxyl groups. Polyetherols can be prepared by ring opening polymerization of cyclic ethers such as tetrahydrofuran or alkylene oxides with a starter molecule. Suitable starter molecules include water, polyhydroxyl functional materials, polyester polyols and amines.

Suitable acrylic (meth)acrylate oligomers (sometimes also referred to in the art as “acrylic oligomers”) include oligomers which may be described as substances having an oligomeric acrylic backbone which is functionalized with one or (meth)acrylate groups (which may be at a terminus of the oligomer or pendant to the acrylic backbone). The acrylic backbone may be a homopolymer, random copolymer or block copolymer comprised of repeating units of acrylic monomers. The acrylic monomers may be any monomeric (meth)acrylate such as C1-C6 alkyl (meth)acrylates as well as functionalized (meth)acrylates such as (meth)acrylates bearing hydroxyl, carboxylic acid and/or epoxy groups. Acrylic (meth)acrylate oligomers may be prepared using any procedures known in the art such as oligomerizing monomers, at least a portion of which are functionalized with hydroxyl, carboxylic acid and/or epoxy groups (e.g., hydroxyalkyl(meth)acrylates, (meth)acrylic acid, glycidyl (meth)acrylate) to obtain a functionalized oligomer intermediate, which is then reacted with one or more (meth)acrylate-containing reactants to introduce the desired (meth)acrylate functional groups.

According to certain embodiments of the invention, at least one polydiene (meth)acrylate oligomer or hydrogenated polydiene (meth)acrylate oligomer is utilized as a co-agent. The polydiene segment of such oligomers may be comprised of one or more dienes, such as butadiene or isoprene, in polymerized form. It is also possible for the polydiene segment to be a copolymer of at least one diene monomer and at least one vinyl aromatic monomer, such as styrene. Such oligomers may be prepared, for example, by the introduction of acrylate or methacrylate functional groups onto a polydiene or hydrogenated (including partially hydrogenated) polydiene such as at the terminal ends of such polydienes. For example, the polydiene or hydrogenated polydiene may have hydroxyl groups (which may be at terminal positions of the polymer chain and/or along the polymer backbone) which are converted to (meth)acrylate groups by esterification (using (meth)acrylic acid, (meth)acrylic anhydride, (meth)acryloyl halide, or C1-C4 alkyl (meth)acrylate, for example). Another synthetic approach is to react a hydroxyl-functionalized polydiene or hydroxyl-functionalized hydrogenated polydiene with a diisocyanate to place reactive isocyanate groups on the polydiene or hydrogenated polydiene (for example, at terminal positions of the polydiene chain) and then react the isocyanate-functionalized polydiene or isocyanate-functionalized hydrogenated polydiene with a compound containing an isocyanate-reactive group (such as a hydroxyl group) and one or more (meth)acrylate groups (e.g., hydroxyethyl (meth)acrylate, trimethylolpropane di(meth)acrylate). Alternatively, a compound containing an isocyanate-reactive group such as a hydroxyl group and one or more (meth)acrylate groups may be reacted with a diisocyanate to obtain an isocyanate- and (meth)acrylate-functionalized compound that is then reacted with a polyhydroxyl-functionalized polydiene or polyhydroxyl-functionalized hydrogenated polydiene. The backbone of the polydiene may be prepared by homopolymerization of a diene such as butadiene or isoprene, copolymerization of two or more different dienes, or polymerization of at least one diene with at least one non-diene co-monomer such as a vinyl aromatic compound like styrene. Hydrogenated polydienes may be prepared by hydrogenating, fully or partially, such polydienes to remove or reduce the content of carbon-carbon double bonds (ethylenic unsaturation) in the polydiene. For example, a polybutadiene may be converted to a “poly(ethylene-butylene)” by hydrogenation. Suitable polydiene (meth)acrylate oligomers include the alkoxylated polybutadiene (meth)acrylate oligomers described in U.S. Pat. Pub. Nos. 2005/0054798 and 2007/0185268, the entire disclosures of which are incorporated herein by reference in their entirety for all purposes. Suitable hydrogenated polybutadiene (meth)acrylate oligomers include the poly(ethylene-butylene) (meth)acrylate oligomers described in U.S. Pat. Pub. No. 2005/0154121, the entire disclosure of which is incorporated herein by reference in its entirety for all purposes. The use of polydiene (meth)acrylate oligomer and/or hydrogenated polydiene (meth)acrylate oligomer as a co-agent in the present invention is particularly advantageous wherein the thermoplastic polymer is relatively nonpolar (as in the case of polyolefins, for example), as such oligomers generally have a high degree of compatibility with such thermoplastic polymers.

The masterbatch compositions of the present invention may alternatively or additionally contain one or more multi(meth)acrylate-functionalized resins which have two to four (meth)acrylate functional groups per molecule and a number average molecular weight of less than 500 daltons. Such multi(meth)acrylate-functionalized resins may correspond to Formula (Ia):

R(OC(═O)CR′═CH₂)ₓ (Ia)

wherein R is an organic moiety, R′ is —H or —CH₃, x is an integer of 2 to 4, and the multi(meth)acrylate-functionalized resin has a molecular weight of less than 500 daltons. According to certain embodiments, R is a hydrocarbon moiety (that is, R does not contain any atoms other than carbon and hydrogen atoms). Such a multi(meth)acrylate-functionalized resin may be referred to as one having a hydrocarbon core structure. However, in other embodiments R contains one or more heteroatoms in addition to carbon atoms and hydrogen atoms. For example, R may contain one or more oxygen atoms, which may be present in the form of ester groups, ether groups, hydroxyl groups and the like. R may be aliphatic in certain embodiments of the invention, but it is also possible for R to contain one or more aromatic rings.

Multi(meth)acrylate-functionalized resins corresponding to Formula (Ia) include di-, tri- and tetra(meth)acrylates of polyalcohols. Suitable examples of such resins include trimethylolpropane tri(meth)acrylate; tris-hydroxyethyl isocyanurate tri(meth)acrylate; pentaerythritol tetra(meth)acrylate; pentaerythritol tri(meth)acrylate; 1,4-butanediol di(meth)acrylate; 1,6-hexanediol di(meth)acrylate; cyclohexane dimethanol di(meth)acrylate; 1,3-butanediol di(meth)acrylate; 1,12-dodecanediol di(meth)acrylate; tricyclodecane dimethanol di(meth)acrylate; neopentyl glycol di(meth)acrylate; ethylene glycol di(meth)acrylate; 1,3-propanediol di(meth)acrylate; diethylene glycol di(meth)acrylate; dipropylene glycol di(meth)acrylate; tripropylene glycol di(meth)acrylate; glycerol tri(meth)acrylate; di-trimethylolpropane tetra(meth)acrylate; and the like and combinations thereof. Alkoxylated variants of the aforementioned compounds are also suitable for use as multi(meth)acrylate-functionalized resins in the present invention, wherein the base polyalcohol has been alkoxylated with one or more alkylene oxides such as ethylene oxide and/or propylene oxide prior to being (meth)acrylated. The resin may contain, for example, from 1 to 10 oxyalkylene units per molecule. Examples of such variants include alkoxylated trimethylolpropane tri(meth)acrylates; alkoxylated tris-hydroxyethyl isocyanurate tri(meth)acrylates; alkoxylated pentaerythritol tetra(meth)acrylates; alkoxylated pentaerythritol tri(meth)acrylates; alkoxylated 1,4-butanediol di(meth)acrylates; alkoxylated 1,6-hexanediol di(meth)acrylates; alkoxylated cyclohexane dimethanol di(meth)acrylates; alkoxylated 1,3-butanediol di(meth)acrylates; alkoxylated 1,12-dodecanediol di(meth)acrylates; alkoxylated tricyclodecane dimethanol di(meth)acrylates; alkoxylated neopentyl glycol di(meth)acrylates; alkoxylated glycerol tri(meth)acrylates; alkoxylated di-trimethylolpropane tetra(meth)acrylates; and the like and combinations thereof.

Specific examples of suitable multi(meth)acrylate-functionalized resins include, but are not limited to, dipentaerythritol pentaacrylate; di-trimethylolpropane tetraacrylate; 4EO pentaerythritol tetraacrylate (i.e., ethoxylated pentaerythritol tetraacrylate containing four oxyethylene units per molecule); 3PO trimethylolpropane triacrylate (i.e., propoxylated trimethylolpropane containing three oxypropylene units per molecule), 6PO trimethylolpropane triacrylate (i.e., propoxylated trimethylolpropane containing six oxypropylene units per molecule), tris-hydroxyethyl isocyanurate triacrylate, trimethylolpropane triglycidyl ether triacrylate, polybutadiene diacrylate, and branched polyester acrylate oligomers having three or more acrylate functional groups per molecule.

### Scorch Retarders

When the masterbatch compositions of the present invention are to be formulated using at least one multi(meth)acrylate-functionalized resin having a relatively low (meth)acrylate equivalent weight (e.g., less than 500 daltons), the masterbatch compositions advantageously additionally contains at least one scorch retarder. However, one or more scorch retarders may be present in the masterbatch composition even if the multi(meth)acrylate-functionalized resin(s) has or have a relatively high (meth)acrylate equivalent weight. The function of the scorch retarder(s) is to reduce, inhibit or even completely avoid degradation or reaction of the multi(meth)acrylate-functionalized resin component of the masterbatch composition, both during compounding of the masterbatch and also during the subsequent blending of the masterbatch composition with additional thermoplastic polymer to prepare a polymer composition which is to be formed into a useful article, such as a film, and then crosslinked. At the same time, however, the scorch retarder should not interfere with the ability to react the multi(meth)acrylate-functionalized resin(s) (through exposure to ionizing radiation, for example) in a manner which results in the desired degree of crosslinking in the finished article. When the masterbatch composition comprises one or more multi(meth)acrylate-functionalized resins of low (meth)acrylate equivalent weight, the incorporation of relatively high loadings of scorch retarder in the masterbatch composition has been found to be necessary in view of the tendency of such low (meth)acrylate equivalent weight multi(meth)acrylate-functionalized resins to react (cure) under the anaerobic and high temperature conditions generally needed to prepare a compounded composition containing a thermoplastic polymer with a relatively high melting or softening point such as polyethylene.

The minimum amount of scorch retarder required to achieve a satisfactory level of stabilization of the multi(meth)acrylate-functionalized resin during preparation of the masterbatch composition will vary somewhat depending upon a number of factors, such as the degradation susceptibility of the multi(meth)acrylate-functionalized resin, the particular compounding conditions and equipment used, the activity (effectiveness) of the scorch retarder selected, and so forth. Generally speaking, however, at least 1 part by weight of at least one scorch retarder per 100 parts by weight of multi(meth)acrylate-functionalized resin preferably is utilized in formulating the masterbatch composition, when a multi(meth)acrylate-functionalized resin having a (meth)acrylate equivalent weight of less than 500 daltons is used. In other embodiments, at least 2 parts by weight or at least 3 parts by weight of at least one scorch retarder per 100 parts by weight of multi(meth)acrylate-functionalized resin are present in the masterbatch composition. Typically, the amount of scorch retarder is not more than 20, not more than 15 or not more than 10 parts by weight per 100 parts by weight of multi(meth)acrylate-functionalized resin. Combinations of two or more different scorch retarders may be employed.

According to certain embodiments of the invention, the scorch retarder (or combination of scorch retarders) and the amount of scorch retarder(s) are selected so as to be effective in increasing the degradation onset temperature observed by differential scanning calorimetry (DSC) for the co-agent(s) above the maximum processing temperature to be used in compounding the masterbatch composition or in forming films based on polymer compositions containing the co-agent(s). Preferably, the degradation onset temperature is increased to a temperature which is at least 5° C., at least 10° C., at least 15° C. or at least 20° C. above the maximum processing temperature. The degradation onset temperature may be measured using ASTM E2550-17.

Amino alkyl phenol scorch retarders and acid salts thereof are particularly useful in the present invention. Such scorch retarders, which are described for example in U.S. Pat. Nos. 4,857,571 and 5,696,190 (each of which is incorporated herein by reference in its entirety for all purposes), may be generally described as phenolic compounds in which an aromatic ring is substituted with at least one hydroxyl group, at least one amino group (in particular, at least one tertiary amino group) and at least one (preferably two) alkyl groups. Examples of suitable amino alkyl phenol scorch retarders include, but are not limited to, 2,6-dimethyl-4-(methyl ethyl amino) methyl phenol; 2,6-diethyl-4-(dimethylamino) methyl phenol; 2,6-di-t-butyl-4-(dimethylamino) methyl phenol; 2,6-di-t-butyl-4-(dimethylamino) ethyl phenol; 2,6-di-t-amyl-4-(dimethylamino) ethyl phenol; 2,6-di-butyl-4-(methyl(cyclohexyl)amino) methyl phenol; 2,64-butyl-4-(methyl (phenyl) amino) n-propyl phenol; 2,6-di-t-amyl-4-(methyl(benzyl)amino) ethyl phenol; 2,6-di-n-(methyl(4-t-butyl-benzyl)amino)n-propyl phenol; and 2,6-di-t-butyl-4-(dimethylamino) n-hexyl phenol; and combinations thereof.

Acid salts of such amino alkyl phenols are also useful as scorch retarders. The anionic portion(s) of such salts may be derived from any suitable organic (e.g., carboxylic) acid (which may include one or more functional groups other than a carboxylic acid functional group, such as a hydroxyl group, a vinyl group, a cyano group or the like) or inorganic acid. Exemplary carboxylic acids include formic acid, acetic acid, propionic acid, butyric acid, valeric acid, hexanoic acid, heptanoic acid, octanoic acid, pelargonic acid, decanoic acid, lauric acid, myristic acid, palmitic acid, stearic acid, oleic acid, benzoic acid, glycolic acid, lactic acid, glyoxylic acid, acrylic acid, vinyl acetic acid, phenyl acetic acid, itaconic acid, malonic acid, and cyanoacetic acid.

Tocopherols represent another suitable type of scorch retarder that can be utilized in the masterbatch compositions of the present invention. Any of the known tocopherols (e.g., alpha, beta, gamma, delta) or combinations thereof may be used.

One or more other types of scorch retarders may be used instead of or in addition to the amino alkyl phenol, amino alkyl phenol acid salt, and tocopherol scorch retarders described above. Such other types of scorch retarders include phenolic and amine scorch retarders generally and in particular hindered phenols and hindered amines (other than the aforementioned amino alkyl phenol scorch retarders), phosphites, organic phosphates, quinones, hydroquinones, phenothiazines, nitroso compounds and the like and combinations thereof.

In desirable embodiments of the invention, the scorch retarder(s), amount of scorch retarder, and processing conditions used to prepare the masterbatch composition are selected such that less than 30%, less than 20%, less than 10%, less than 5% or less than 1% by weight of the multi(meth)acrylate-functionalized resin used to prepare the masterbatch composition reacts or degrades. That is, at least 70%, at least 80%, at least 90%, at least 95% or at least 99% by weight of the initial amount of multi(meth)acrylate-functionalized resin employed in the formulation of the masterbatch composition remains intact (unreacted) in the final masterbatch composition. It will also be desirable to select the scorch retarder(s), amount of scorch retarder, and processing conditions used to prepare the masterbatch composition such that crosslinking of the thermoplastic polymer is controlled and the masterbatch composition remains thermoplastic in character and thus capable of being readily blended with additional thermoplastic polymer to produce the polymer composition. Further, it will also be advantageous for the masterbatch composition to be sufficiently stabilized against premature crosslinking such that little or no crosslinking or reaction of the multi(meth)acrylate-functionalized resin in the masterbatch composition takes place during production of the polymer composition and its shaping into a desired article such as a film (in the absence of ionizing radiation). For example, the masterbatch composition obtained (or the polymer composition prepared therefrom, prior to being exposed to a source of ionizing radiation) may be limited in its degree of crosslinking such that it has a gel content less than 10 weight percent, less than 8 weight percent, less than 6 weight percent, less than 4 weight percent, less than 2 weight percent, less than 1 weight percent, less than 0.5 weight percent or even 0 weight percent, based on the weight of the film. Gel content can be determined by soaking the film in refluxing xylene for 12 hours, as described in ASTM D 2765-90, method B. The insoluble polymer is isolated, dried and weighed. The weight of insoluble polymer divided by the initial weight of the film, times 100, is reported as the percent gel content. Corrections are made for the known weight of any non-polymeric component(s).

Other Additives A masterbatch composition in accordance with the present invention, or a polymer composition prepared from such a masterbatch composition, may contain one or more additives in addition to those previously described. Suitable additives may include, but are not limited to, photoinitiators; antioxidants; surface tension modifiers; anti-block agents; plasticizers; processing aids such as processing waxes and oils, crosslinking agents (other than the multi(meth)acrylate-functionalized resins described herein), dispersants, blowing (foaming) agents, UV stabilizers, antimicrobial agents; antioxidants; antistatic agents; fillers and reinforcing agents; flame retardants; hydrolytic stabilizers; lubricants; acid neutralizers or scavengers or halogen scavengers; mold release agents; pigments, dyes and colorants; heat stabilizers; scratch/mar additives; and deodorizers.

In certain embodiments, the masterbatch compositions and the polymer compositions prepared therefrom may comprise one or more additional additives, besides the multi(meth)acrylate-functionalized resins described herein, which participate in or otherwise promote crosslinking of the polymer compositions. For example, the masterbatch and polymer compositions may comprise one or more ethylenically unsaturated co-agents other than the herein-described multi(meth)acrylate-functionalized resins, such as allyl-functionalized co-agents (e.g., triallyl cyanurate), mono(meth)acrylate-functionalized co-agents, or multi(meth)acrylate-functionalized co-agents having a number average molecular weight of less than 500 daltons and fewer than five (meth)acrylate-functional groups per molecule. However, according to certain embodiments, no ethylenically unsaturated co-agent is present in the masterbatch and polymer compositions other than multi(meth)acrylate-functionalized resins which meet at least one of the following criteria: i) at least five (meth)acrylate functional groups per molecule; or ii) a number average molecular weight of at least 500 daltons. In still further embodiments, as mentioned above, the masterbatch and polymer compositions may contain one or more photoinitiators. However, in certain embodiments the masterbatch and polymer compositions do not contain any photoinitiator. In still further embodiments, the masterbatch and polymer compositions may comprise one or more free radical initiators such as azo and/or peroxide compounds as well as optionally accelerators or promoters for such free radical initiators. However, in certain embodiments the masterbatch and polymer compositions do not contain any such free radical initiators, accelerators or promoters.

Further, although it is possible for the masterbatch composition and the polymer composition to comprise at least one photoinitiator (which may be activated by exposing the polymer composition to light, such as UV light or light from an LED, in order to initiate crosslinking of the polymer composition involving reaction of the multi(meth)acrylate-functional resin), according to certain embodiments neither the masterbatch composition nor the polymer composition contains any photoinitiator. In such cases, crosslinking of the polymer composition may be accomplished by exposing the polymer composition to ionizing radiation, such as electron beam radiation or gamma radiation (as explained elsewhere herein).

### Preparation of Masterbatch Compositions

The components of the masterbatch composition may be combined using any procedures and equipment suitable for such purpose. Generally speaking, however, it will be highly desirable to avoid compounding or mixing the thermoplastic polymer and multi(meth)acrylate-functionalized resins having a relatively low (meth)acrylate equivalent weight (e.g., less than 500 daltons) in the absence of scorch retarder, due to the tendency of the multi(meth)acrylate-functionalized resin to react or degrade at elevated temperatures unless adequately stabilized. For this reason, compounding methods are advantageously used in which scorch retarder is added to the multi(meth)acrylate functionalized resin and then compounded with the thermoplastic polymer. Alternatively, the thermoplastic polymer, scorch retarder and multi(meth)acrylate-functionalized resin may be compounded simultaneously. Typically, the compounding is carried out at a temperature sufficiently effective to soften or melt the thermoplastic polymer, thus facilitating homogenous incorporation of the scorch retarder and/or multi(meth)acrylate-functionalized resin into the thermoplastic polymer, while avoiding temperatures at which significant decomposition or reaction of the multi(meth)acrylate-functionalized resin takes place. The effective compounding temperature range will, of course, vary depending upon the characteristics of the thermoplastic polymer and the multi(meth)acrylate-functionalized resin such as the melting point of the thermoplastic polymer and the thermal stability of the multi(meth)acrylate-functionalized resin.

The one or more multi(meth)acrylate-functionalized resins and the one or more scorch retarders (if used) can be incorporated into the thermoplastic polymer, which functions as a carrier polymer in the masterbatch composition, by mixing such additives (and optionally one or more additional additives as well) with the thermoplastic polymer at an elevated temperature, which typically is carried out at a temperature or temperatures of at least 15° C. above the melting or softening point of the thermoplastic polymer. Melt mixing in this manner can be effected in a conventional mixing device and/or extruder, using techniques well known in the polymer field.

One preferred method for preparing a masterbatch composition in accordance with the present invention is to add an admixture of the multi(meth)acrylate-functionalized resin co-agent(s) and scorch retarder(s) into a continuous mixer with the thermoplastic polymer at a temperature just above (e.g., 1-10° C. above) the melt temperature of the thermoplastic polymer and mix for a short residence time in the mixer (e.g., 1-10 minutes), then transfer the resulting masterbatch composition to a single screw extruder for further compounding, extrusion and pelletization.

Another preferred method for preparing a masterbatch composition in accordance is to add an admixture of the multi(meth)acrylate-functionalized resin coagent(s) and scorch retarder(s) into a feeder/hopper and to feed the mixture into a twin-screw extruder with thermoplastic polymer barrel at a temperature above (e.g. 10-40° C. above) the melt temperature of the thermoplastic polymer.

Preparation of the masterbatch composition may include an optional pelletizing step, wherein the masterbatch composition is further processed to a particulate form which is capable of being readily and conveniently handled, stored, processed and subsequently used to prepare polymer compositions that are then converted or otherwise formed into useful articles such as films, fibers and the like. As used herein, the term “pellets” refers to powders, grains, granules or pellets of any size and shape, as is well known in the art. Pellets are typically formed by melt mixing the components of the masterbatch composition and then extruding the masterbatch composition melt via a die in a conventional extrusion apparatus, such as a single or twin screw extruder. The extrudate from the die is then cut into pellets in a known manner and cooled, thereby providing solid pellets of the masterbatch composition. If desired, such pellets may be subjected to further processing such as sizing, milling or the like.

The components of the masterbatch composition, their relative proportions and the processing conditions employed in the preparation and pelletization of the masterbatch composition may, in certain embodiments of the invention, be selected to provide pellets which are solid, dry and non-blocking, despite the incorporation of relatively high levels (e.g., 10 to 40% by weight) of multi(meth)acrylate-functionalized resin(s), which typically are liquids at 25° C. In such embodiments, the multi(meth)acrylate-functionalized resin(s) exhibit a high degree of compatibility with the thermoplastic polymer and consequently do not exude or otherwise separate from the pelletized masterbatch composition.

According to certain embodiments of the invention, a masterbatch composition may be prepared in the form of pellets using a method comprised of the following steps:
a) feeding a thermoplastic polymer into an extruder having an extruder barrel, wherein the thermoplastic polymer is heated to a temperature effective to soften or melt the thermoplastic polymer;
b) mixing the thermoplastic polymer which is in softened or molten form in the extruder with at least one multi(meth)acrylate-functionalized resin and at least one scorch retarder in liquid form (or, alternatively, multi(meth)acrylate-functionalized resin alone, if the resin(s) is or are sufficiently stable at the temperature at which the thermoplastic polymer is being compounded), wherein the at least one multi(meth)acrylate-functionalized resin and/or at least one scorch retarder may be introduced into the extruder by injection through a vent or port in the extruder barrel, to obtain a compound;
c) extruding the compound through a die to form a strand; and
d) chopping the strand to form pellets comprised of the masterbatch composition.

The extruder may be any type of extruder suitable for extruding a thermoplastic polymer, such as, for example, a single screw extruder or a twin screw extruder. Step b) may be carried out using, for example, liquid injection delivery equipment which includes a positive pressure diaphragm pump, a peristaltic pump or a progressive cavity pump. Pelletization step d) may, for example, be carried out underwater.

According to certain embodiments of the invention, a masterbatch composition may be prepared in the form of pellets using a method comprised of the following steps:
a) feeding a thermoplastic polymer to a continuous mixer (such as a Farrell Continuous Mixer (FCM)), wherein the thermoplastic polymer is heated to a temperature effective to soften or melt the thermoplastic polymer;
b) injecting the thermoplastic polymer which is in softened or molten form in the continuous mixer with a liquid mixture comprised of at least one multi(meth)acrylate-functionalized resin and at least one scorch retarder (or, alternatively, multi(meth)acrylate-functionalized resin alone, if the resin(s) is or are sufficiently stable at the temperature at which the thermoplastic polymer is being compounded) to obtain a compound;
c) transferring the compound to a feeder connected to a single-screw extruder:
d) extruding the compound through a die to form a strand; and
e) chopping the strand to form pellets comprised of the masterbatch composition.

In the above-mentioned methods, the extruder may be any type of extruder suitable for extruding a thermoplastic polymer, such as, for example, a single screw extruder or a twin screw extruder. Step b) may be carried out using, for example, liquid injection delivery equipment which includes a positive pressure diaphragm pump, peristaltic pump or a progressive cavity pump. Pelletization step e) may, for example, be carried out underwater. The method may be carried out in a continuous manner.

### Uses for Masterbatch Compositions

Masterbatch compositions in accordance with the present composition are useful in the preparation of polymer compositions. Generally speaking, such polymer compositions may be obtained by blending a masterbatch composition in accordance with the invention with an additional quantity of thermoplastic polymer, which typically is the same as (or at least is of the same type as) the thermoplastic polymer employed when formulating the masterbatch composition. For example, the thermoplastic polymer in the masterbatch composition may be a polyethylene (e.g., a LDPE) and the thermoplastic polymer blended with the masterbatch composition may also be a polyethylene (e.g., a LDPE).

For example, a polymer composition may be prepared by a process comprising blending the masterbatch composition with at least one thermoplastic polymer to obtain the polymer composition. One or more masterbatch compositions can be used in preparing the polymer composition. According to certain embodiments of the invention, all of the multi(meth)acrylate-functionalized resin and scorch retarder present in the polymer composition is provided by means of the masterbatch composition(s). For example, the at least one thermoplastic polymer combined with the masterbatch composition may be free or essentially free of multi(meth)acrylate-functionalized resin. However, it is also possible to add additional amounts of multi(meth)acrylate-functionalized resin and/or scorch retarder to the polymer composition separately from the masterbatch composition(s). Thus, all of the needed multi(meth)acrylate-functionalized resin and/or all of the needed scorch retarder can be furnished in the form of one or more masterbatch compositions in accordance with the present invention, or, alternatively, part of the needed multi(meth)acrylate-functionalized resin and/or scorch retarder can be added separately from a masterbatch composition, e.g., added separately during preparation of the polymer composition.

The weight proportions of the masterbatch composition and the further thermoplastic polymer compounded with the masterbatch composition to provide a polymer composition may be varied and controlled to achieve target amounts of various components in the polymer composition. Knowing the multi(meth)acrylate-functionalized resin content of the masterbatch composition and the desired level of multi(meth)acrylate-functional resin in the polymer composition that is to be crosslinked to provide a useful article such as a crosslinked film, a manufacturer may for example readily calculate how much of the masterbatch composition must be combined with the additional thermoplastic polymer.

Polymer compositions comprising masterbatch compositions in accordance with the present invention may be formed into articles and crosslinked. The article may be formed first and then crosslinked, or forming and crosslinking may be carried out simultaneously. Generally speaking, the polymer composition should not be crosslinked to a high degree before the article is formed, since a highly crosslinked polymer composition may be difficult to form using conventional thermoplastic processing techniques.

Any type of article may be fabricated using polymer compositions comprised of masterbatch compositions in accordance with the invention, such as, for example, blow molded articles (e.g., containers), rotation molded (rotomolded) articles (e.g., containers), injection molded parts, fabric coated membranes, and the like.

However, masterbatch compositions in accordance with the invention are particularly useful for the manufacture of films. Such films may be single layered films or multilayered (laminate) films, which can be formed by blown extrusion, extrusion coating, or extrusion lamination (such as in-between web based materials), and other such processes known in the art from polymer compositions prepared using masterbatch compositions in accordance with the invention. For example, the film may be formed by a blown film process, a cast film process, or an extrusion process. A multilayer film may comprise one or more polymeric films (including at least one film comprised of a polymer composition in accordance with the present invention), polymeric non-wovens, woven fabrics or pulp- and paper-based products, and/or metallic foils including metallized polymeric films (laminates). The film may consist of a single layer or may comprise two or more layers.

A film may be prepared by selecting the thermoplastic polymers or blends suitable for making each layer; forming a film of each layer, and where the film contains more than one layer, bonding the layers, blow molding, coextruding, or casting one or more layers. Desirably, the film layers are bonded continuously over the interfacial area between films (film layers).

Laminates, manufactured either by means of heat lamination, extrusion coating and/or extrusion lamination, combine molten polymer (melt coating) or molten polymer film (heat lamination) surface under pressure, with a range of web based materials including polymeric films, non-wovens, fabrics, paper and board, metal foils or metallized polymeric films. In general, the invention is not limited to film, but is also useful for example, for blow molded containers and other articles, rotation molded containers and other articles, injection molded parts, fabric coated membranes, and the like.

For each layer, typically, it is suitable to extrusion blend the components (e.g., masterbatch composition and additional thermoplastic polymer, which typically will be the same as, or the same type of thermoplastic polymer as, the thermoplastic polymer component of the masterbatch composition) and any additional additives, such as slip, anti-block, and polymer processing aids. The extrusion blending should be carried out in a manner such that an adequate degree of dispersion is achieved. The parameters of extrusion blending will necessarily vary depending upon the components. However, typically, the total polymer deformation (that is, mixing degree) is important, and is controlled by, for example, the screw-design and the melt temperature. The melt temperature during film forming will depend on the film components.

After extrusion blending, a film structure is formed. A film structure may be made by conventional fabrication techniques, for example, bubble extrusion, biaxial orientation processes (such as tenter frames or double bubble processes), cast/sheet extrusion, direct membrane extrusion, coextrusion and lamination. According to certain embodiments, the film is oriented. In other embodiments, however, the film is non-oriented.

The melt temperature during the film forming will vary depending on the components of the film. Typically, the melt temperature may be from 175° C. to 300° C.

Sheets of the film can be bonded by heat sealing or by use of an adhesive, and preferably by heat sealing. Heat sealing can be effected using conventional techniques, including, but not limited to, a hot bar, impulse heating, side welding, ultrasonic welding, or other alternative heating mechanisms.

The films of the present invention may be made to any thickness depending upon the application. In various embodiments, the film may have a total thickness of from 25 to 5000 microns, from 25 to 1500 microns, or from 25 to 500 microns, for example. In other embodiments, the film has a thickness from 50 microns to 5000 microns, from 50 microns to 1000 microns, from 50 microns to 500 microns, or from 50 microns to 200 microns. The thickness of a film can be measured using a micrometer.

In certain embodiments, an inventive film in accordance with the invention is crosslinked to an extent effective to provide a gel content greater than 20 weight percent, greater than 30 weight percent, greater than 40 weight percent, or greater than 50 weight percent, based on the weight of the film. Gel content can be determined by soaking the film in refluxing xylene for 12 hours, as described in ASTM D 2765-90, method B. The insoluble polymer is isolated, dried and weighed. The weight of insoluble polymer divided by the initial weight of the film, times 100, is reported as the percent gel content. Corrections are made for the known weight of any non-polymeric component(s).

According to aspects of the invention the rheological, physical, mechanical and other properties of the polymer composition obtained from the masterbatch composition are tailored according to the requirements of the intended use of the polymer composition by treating the polymer composition with ionizing radiation. Preferably, the ionizing radiation is gamma radiation or electron beam radiation (also known as beta radiation).

The gamma radiation and electron beam radiation treatment may be carried out by means of irradiation procedures known in the art. Electron beams, also known as beta-rays, are generated by electron accelerators generally known in the art. Gamma-rays used in industrial applications are generally generated in the radioactive conversion of cobalt 60 (⁶⁰Co) to nickel 60 (⁶⁰Ni). The thereby emitted gamma-rays have a high penetration depth. While the time of irradiation with beta-rays is generally within seconds, the time of irradiation with gamma-rays can be within hours. The radiation dose applied to polymer compostions according to the invention is not particularly limited but normally is in the range of about 10 kGy to about 300 kGy (kilo Gray), e.g., about 20 kGy to about 100 kGy.

In one embodiment of the invention, the film is crosslinked using electron beam radiation. For example, the film may be crosslinked at a dosage of electron beam radiation of from 5 kGy to 400 kGy (1 kGy=1 kJ/kg=0.1 MRAD) or from 50 kGy to 200 kGy. In one embodiments, the film may be crosslinked using an electron beam radiation source set at a voltage from 50 keV to 5 MeV or from 200 keV to 2 MeV.

In other embodiments, the film is crosslinked with gamma radiation at a level of 5 kGy to 400 kGy or 50 kGy to 200 kGy.

In addition to films (e.g., blown films, cast films, extruded films), the masterbatch compositions and polymer compositions of the present invention are useful for the production of various types of articles, particularly articles in which crosslinked thermoplastic polymers have conventionally been used. For example, the inventive compositions are suitable for laminates, extruded sheets, adhesives, and tie layers between extruded sheets, tie layers between cast sheets, tie layers between films and tie layers between profiles. Additional types of articles which can be made using masterbatch and polymer compositions in accordance with the present invention include containers; carpet components; adhesives; fabrics; membranes; wire coatings and sheaths; cable coatings and sheaths; protective apparel; coatings; coated articles; artificial leather; artificial turf; fibers; packaging; household items; vehicle components; building components; electrical insulation components, furniture components; appliance components; gaskets; medical device components; tubes/pipes/conduits; weatherstripping and seals; and liners (for example, vessel and tank liners, roofing liners, geomembranes and tunnel liners).

Suitable methods for forming polymer compositions prepared using masterbatch compositions in accordance with the present invention into useful articles include, but are not limited to, wire and cable extrusion; rotomolding, profile extrusion, injection molding; compression molding; transfer molding; overmolding extrusion; blow molding; injection blow molding; thermoforming; top forming; press blowing; slot die extrusion; sheet die extrusion; foam extrusion; blown film extrusion; monotape and monofilament extrusion; fiber spinning (e.g., melt spinning of fibers); powder coating; and the like and combinations of such techniques.

Various aspects of the present invention may be summarized as follows:

Aspect 1: A masterbatch composition comprised of:
a) at least one non-elastomeric thermoplastic polymer;
b) at least 5%, preferably at least 10%, by weight, based on the total weight of the masterbatch composition, of at least one multi(meth)acrylate-functionalized resin having at least two (meth)acrylate functional groups per molecule; and
c) when the at least one multi(meth)acrylate-functionalized resin has a (meth)acrylate equivalent weight below 500 daltons, at least one scorch retarder.

Aspect 2: The masterbatch composition of Aspect 1, comprising at least 1 part by weight per 100 parts by weight of multi(meth)acrylate-functionalized resin of at least one scorch retarder.

Aspect 3: The masterbatch composition of Aspect 1 or 2, wherein the at least one multi(meth)acrylate-functionalized resin includes at least one multi(meth)acrylate-functionalized resin meeting at least one of the following criteria:
i) at least five (meth)acrylate functional groups per molecule; or
ii) a number average molecular weight of at least 500 daltons.

Aspect 4: The masterbatch composition of any of Aspect 1 to 3, wherein if a multi(meth)acrylate-functionalized resin is present which is an oligomer, the masterbatch composition does not comprise photoinitiator.

Aspect 5: The masterbatch composition of any of Aspect 1 to 4, wherein the at least one non-elastomeric thermoplastic polymer includes at least one thermoplastic polymer selected from the group consisting of polyolefins, ethylene vinyl acetate copolymers, ethylene alkyl (meth)acrylate copolymers, and polyamides.

Aspect 6: The masterbatch composition of any of Aspects 1 to 5, wherein the at least one non-elastomeric thermoplastic polymer includes at least one polyethylene.

Aspect 7: The masterbatch composition of any of Aspects 1 to 6, wherein the masterbatch composition is comprised of from 10 to 40%, preferably from 10 to 20%, by weight, based on the total weight of the masterbatch composition, of the at least one multi(meth)acrylate-functionalized resin.

Aspect 8: The masterbatch composition of any of Aspects 1 to 7, wherein the at least one multi(meth)acrylate-functionalized resin includes at least one multi(meth)acrylate-functionalized resin having five or more (meth)acrylate functional groups per molecule and a number average molecular weight of less than 500 daltons.

Aspect 9: The masterbatch composition of any of Aspects 1 to 8, wherein the at least one multi(meth)acrylate-functionalized resin includes at least one multi(meth)acrylate-functionalized resin having three or more (meth)acrylate functional groups per molecule and a number average molecular weight of at least 500 daltons.

Aspect 10: The masterbatch composition of any of Aspects 1 to 9, wherein the at least one multi(meth)acrylate-functionalized resin includes at least one multi(meth)acrylate-functionalized resin having a number average molecular weight of at least 500 daltons.

Aspect 11: The masterbatch composition of any of Aspects 1 to 10, wherein the at least one multi(meth)acrylate-functionalized resin includes at least one multi(meth)acrylate-functionalized resin having a hydrocarbon core structure and a number average molecular weight of at least 500 daltons.

Aspect 12: The masterbatch composition of any of Aspects 1 to 11, wherein the at least one multi(meth)acrylate-functionalized resin includes at least one multi(meth)acrylate-functionalized resin having a number average molecular weight of at least 1000 daltons.

Aspect 13: The masterbatch composition of any of Aspects 1 to 12, wherein the at least one multi(meth)acrylate resin includes at least one multi(meth)acrylate-functionalized resin selected from the group consisting of dipentaerythritol pentaacrylate, di-trimethylolpropane tetraacrylate, 4EO pentaerythritol tetraacrylate, 3PO trimethylolpropane triacrylate, 6PO trimethylolpropane triacrylate, tris-hydroxyethyl isocyanurate triacrylate, trimethylolpropane triglycidyl ether triacrylate, polybutadiene diacrylate, and branched polyester acrylate oligomers having three or more acrylate functional groups per molecule.

Aspect 14: The masterbatch composition of any of Aspects 1 to 13, wherein at least one scorch retarder is present and the at least one scorch retarder includes at least one scorch retarder selected from the group consisting of amino alkyl phenol scorch retarders, acid salts of amino alkyl phenol scorch retarders, tocopherol scorch retarders and combinations thereof.

Aspect 15: Pellets comprised of the masterbatch composition of any of Aspects 1 to 14.

Aspect 16: The pellets of Aspect 15, wherein the pellets are solid, dry and non-blocking.

Aspect 17: A method of making a film, comprising combining the masterbatch composition of any of Aspects 1 to 14 or the pellets of Aspect 15 or Aspect 16 with a second non-elastomeric thermoplastic polymer, which may be the same as or different from the first non-elastomeric thermoplastic polymer, to obtain a polymer composition and forming the polymer composition into a film.

Aspect 18: A film comprised of.
a) at least one non-elastomeric thermoplastic polymer;
b) at least one multi(meth)acrylate-functionalized resin, wherein the at least one multi(meth)acrylate-functionalized resin meets at least one of the following criteria:
   at least five (meth)acrylate functional groups per molecule; or
   a number average molecular weight of at least 500 daltons; and
c) when the at least one multi(meth)acrylate-functionalized resin has a (meth)acrylate equivalent weight of less than 500 daltons, at least one scorch retarder.

Aspect 19: A method for making a crosslinked film, wherein the method comprises exposing a film comprised of:
a) at least one non-elastomeric thermoplastic polymer;
b) at least one multi(meth)acrylate-functionalized resin, wherein the at least one multi(meth)acrylate-functionalized resin meets at least one of the following criteria:
   at least five (meth)acrylate functional groups per molecule; or
   a number average molecular weight of at least 500 daltons; and
c) when the at least one multi(meth)acrylate-functionalized resin has a (meth)acrylate equivalent weight of less than 500 daltons, at least one scorch retarder
   to an amount of ionizing radiation effective to crosslink the film.

Aspect 20: A crosslinked film obtained by the method of Aspect 19.

Aspect 21: A method of making a masterbatch composition wherein the masterbatch composition is provided in pellet form, comprising compounding at least one thermoplastic polymer, at least one multi(meth)acrylate-functionalized resin, and, optionally, at least one scorch retarder using either:
a) a twin-screw extruder and liquid injection delivery equipment having either a positive pressure diaphragm pump, peristaltic pump, or progressive cavity pump equipped with a strand die and an underwater pelletizer; or
b) a continuous mixer in-line with a single screw extruder, equipped with a strand die and an underwater pelletizer.

Aspect 22: A method of making pellets of a masterbatch composition, wherein the method comprises:
a) feeding a thermoplastic polymer into an extruder having an extruder barrel, wherein the thermoplastic polymer is heated to a temperature effective to soften or melt the thermoplastic polymer;
b) mixing the thermoplastic polymer which is in softened or molten form in the extruder with a mixture of at least one multi(meth)acrylate-functionalized resin and at least one scorch retarder in liquid form or, if the at least one multi(meth)acrylate-functionalized resin is or are stable at the temperature at which the thermoplastic polymer is being compounded in the absence of scorch retarder, with multi(meth)acrylate-functionalized resin alone in liquid form, wherein the at least one multi(meth)acrylate-functionalized resin and optional at least one scorch retarder is or are optionally injected into the extruder through a vent or port in the extruder barrel, to obtain a compound;
c) extruding the compound through a die to form a strand; and
d) chopping the strand to form pellets comprised of the masterbatch composition.

Aspect 23: A method of making pellets of a masterbatch composition, wherein the method comprises:
a) feeding a thermoplastic polymer to a continuous mixer, wherein the thermoplastic polymer is heated to a temperature effective to soften or melt the thermoplastic polymer;
b) injecting the thermoplastic polymer which is in softened or molten form in the continuous mixer with a liquid mixture comprised of at least one multi(meth)acrylate-functionalized resin and at least one scorch retarder or, if the at least one multi(meth)acrylate-functionalized resin is or are stable at the temperature at which the thermoplastic polymer is being compounded in the absence of scorch retarder, with multi(meth)acrylate-functionalized resin alone to obtain a compound;
c) transferring the compound to a feeder connected to a single-screw extruder:
d) extruding the compound through a die to form a strand; and
e) chopping the strand to form pellets comprised of the masterbatch composition.

Within this specification, embodiments have been described in a way which enables a clear and concise specification to be written, but it is intended and will be appreciated that embodiments may be variously combined or separated without departing from the invention. For example, it will be appreciated that all preferred features described herein are applicable to all aspects of the invention described herein.

In some embodiments, the invention herein can be construed as excluding any element or process step that does not materially affect the basic and novel characteristics of the masterbatch compositions, methods for making the masterbatch compositions, methods for using the masterbatch compositions, and crosslinked articles prepared from the masterbatch compositions. Additionally, in some embodiments, the invention can be construed as excluding any element or process step not specified herein.

Although the invention is illustrated and described herein with reference to specific embodiments, the invention is not intended to be limited to the details shown. Rather, various modifications may be made in the details within the scope and range of equivalents of the claims and without departing from the invention.

### EXAMPLES

### Example 1

Blends of scorch retarder and various multi(meth)acrylate-functionalized resins (co-agents) were prepared as follows. In each case, both the scorch retarder and the multi(meth)acrylate-functionalized resin were liquids at 25° C. The scorch retarder used was alpha tocopherol (Vitamin E).
1) Charge the multi(meth)acrylate-functionalized resin to a mixing vessel equipped with controlled heating to 60° C., in an amount sufficient to represent 96% by weight of the scorch retarder/multi(meth)acrylate functionalized resin blend;
2) Add the scorch retarder in an amount sufficient to represent 4% by weight of the scorch retarder/multi(meth)acrylate functionalized resin blend and mix it together with the multi(meth)acrylate-functionalized resin using a stainless steel impeller at 250 rpm for 30 minutes; and
3) Discontinue heating and discharge the scorch retarder/multi(meth)acrylate functionalized resin blend.

The scorch retarder/multi(meth)acrylate functionalized resin blends are further described in Table 1 below. The amounts stated are in parts by weight. Each of the co-agents is a product of Sartomer (a subsidiary of Arkema).

TABLE 1

| Co-agent | A | B | C | D | E | F | G | H | I |
|---|---|---|---|---|---|---|---|---|---|
| SR533 Triallyl | 100 | | | | | | | | |
| Cyanurate (Control) | | | | | | | | | |
| SR350 Trimethylolpropane | | 96 | | | | | | | |
| Triacrylate Monomer | | | | | | | | | |
| CN307 Polybutadiene | | | 96 | | | | | | |
| Diacrylate Oligomer | | | | | | | | | |
| NTX13940 Hexafunctional | | | | 96 | | | | | |
| Olefinic Acrylate Oligomer | | | | | | | | | |
| SR368 Tris-Hydroxyethyl | | | | | 96 | | | | |
| Isocyanurate Triacrylate | | | | | | | | | |
| Monomer/CN133 Epoxy | | | | | | | | | |
| Triacrylate Oligomer | | | | | | | | | |
| CN2304 Hyperbranched | | | | | | 96 | | | |
| Polyester Acrylate Oligomer | | | | | | | | | |
| SR399 Di-Pentaerythritol | | | | | | | 96 | | |
| Pentaacrylate Monomer | | | | | | | | | |
| SR355 Di- | | | | | | | | 96 | |
| Trimethylolpropane | | | | | | | | | |
| Tetraacrylate Monomer | | | | | | | | | |
| SR501 6 Mole PO | | | | | | | | | 96 |
| Trimethylolpropane | | | | | | | | | |
| Triacrylate | | | | | | | | | |
| Alpha Tocopherol | 0 | 4 | 0 | 4 | 4 | 4 | 4 | 4 | 4 |
| (Vitamin E) | | | | | | | | | |
| Scorch Retarder | | | | | | | | | |

### Example 2

Masterbatches were prepared using linear low density polyethylene (LLDPE) and the blends of Example 1, formed into films and then cured using electron beam radiation in accordance with the following procedures.

Compounding Process: Co-agent A and Co-agent/Scorch Retarder blends B—H were compounded into linear low density polyethylene (Dow DFDA7047) at 0, 5, 10 and 15% co-agent loading levels using a DSM Micro-compounder equipped with a feeder/hopper, heated barrel chamber, two co-rotating screws, air cooling and a strand die to extrude the resulting compound into strands that were then chopped into pellets for processing and testing. The barrel chamber was heated to 150° C. and the screw speed was set at 100 rpm. The co-agent/scorch retarder blends (or just co-agent, in the case of A) and the LLDPE were pre-weighed and pre-dispersed in a plastic container by shaking the container to wet the polymer before addition to the feeder. The die valve was closed and the masterbatch components were added to the compounder incrementally until the torque reached 5000N. The resulting compound was mixed for two minutes before it was extruded and pelletized.
Film Preparation: The compounds (masterbatch compositions) as described above were pressed into 3-5 mil thick films by placing the masterbatch pellets in a circular pattern in the center of two polyethylene terephthalate (PET) release sheets, sandwiching the pellets/release sheets between 6″×12″ Al panels, placing the sandwiched assembly between two heated platens at 150 C, and applying up to 8 metric tons of pressure in a Carver hydraulic press.
Electron Beam (EB) Curing: The masterbatch films were electron beam-cured at 200 eV and 3.75, 7.5 and 15 Mrad EB doses using an ESI electron beam accelerator.
Testing and Analysis of EB-Cured Films: The masterbatch films were tested for tensile mechanical properties (ASTM D882), pendulum tear (ASTM D1922), impact resistance (ASTM D3420), and heat resistance (DMA analysis). The results obtained are shown in Table 2.

TABLE 2
Effect of Co-agent Addition on Tensile Testing of EB Crosslinked LLDPE

| | Stress @ | Stress @ | | Modulus | Energy @ |
|---|---|---|---|---|---|
| | Max Load | Break | Elongation @ | (Tan 1%) | Break |
| Sample | (psi) | (psi) | Break (%) | (psi) | (ft-lbft) |
| 7.5 Mrad | | | | | |
| Control | 2820 | 2807 | 1229 | 15387 | 6.431 |
| 2% Coagent A | 3157 | 3128 | 1185.2 | 16928 | 5.392 |
| 2% Coagent B | 3247 | 3233 | 1238.6 | 17782 | 8.157 |
| 2% Coagent C | 3079 | 3079 | 1263.9 | 14958 | 6.326 |
| 5% Coagent C | 2743 | 2663 | 1007.6 | 16922 | 4.205 |
| 10% Coagent C | 2763 | 2757 | 1088.7 | 17249 | 3.711 |
| 15% Coagent C | 1814 | 1787 | 990.9 | 13727 | 2.587 |
| 5% Coagent D | 3104 | 3097.3 | 1203.8 | 16747 | 5.643 |
| 10% Coagent D | 2726 | 2711 | 1196.8 | 13150 | 4.949 |
| 15% Coagent D | 2006 | 1616 | 1130.1 | 12633 | 3.428 |
| 2% Coagent E | 2602 | 2586 | 1222.4 | 16974 | 5.955 |
| 2% Coagent F | 2563 | 2507 | 1124.4 | 18084 | 4.461 |
| 2% Coagent G | 2266 | 2227 | 1107.6 | 15841 | 5.818 |
| 2% Coagent H | 3190 | 1374 | 1301.4 | 14197 | 8.531 |

### Detailed Results Discussion:

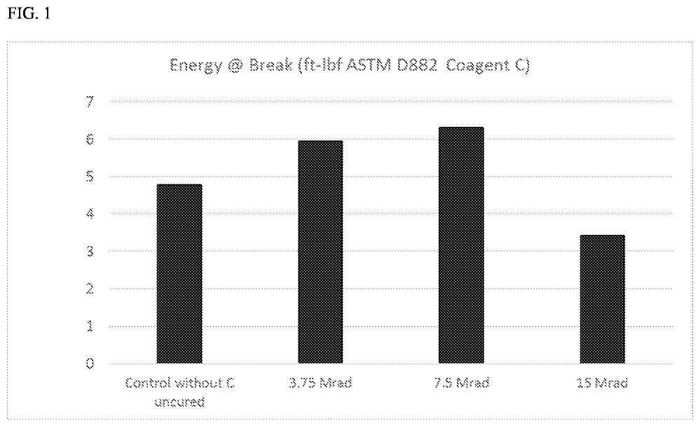

The tensile properties for the LLDPE-coagent modified films were slightly improved over the EB cured control at a lower loading of coagent with a 7.5 Mrad dose. Coagent H at 2% loading exhibits improved Tensile Strength at maximum load and Energy @ Break while maintaining high Elongation at Break, as shown in Table 2. Additionally, higher energy at break was observed using Coagent C at lower doses (3.75 and 7.5 Mrad) as shown in FIG. 1. Higher Energy at Break can be related to higher film toughness.

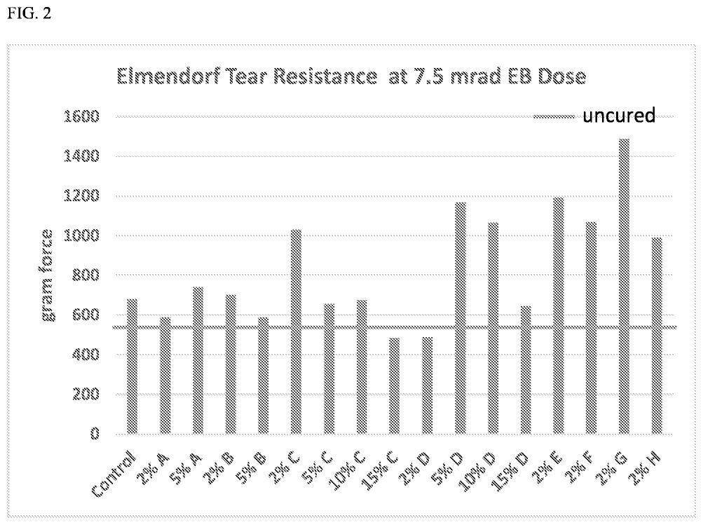

More significant improvement in tear and pendulum impact resistance was observed. FIG. 2 shows that the use of Coagents C and E, which contain higher molecular weight oligomers with acrylate functionality ≤3, resulted in films which exhibited good toughness, resulting in good tear resistance. Films prepared using Coagents D and H, which contained co-agents having high molecular weight (>500 daltons) and acrylate functionality ≥5, exhibited improved tear resistance over the EB-cured control at 7.5 Mrad, with Coagent D at 5% loading and Coagent H at 2% loading.

Coagent I which also has higher molecular weight (>500 daltons) that was EB cured at 3.75 Mrad improved tear resistance in LDPE. The tear resistance for Coagent I was 500 gf versus 164 gf for the EB-cured LDPE control.

More significant improvement in tear and pendulum impact resistance was observed. FIG. 2 shows that the use of Coagents C and E, which contain higher molecular weight oligomers with acrylate functionality ≤3, resulted in films which exhibited good toughness, resulting in good tear resistance. Films prepared using Coagents D and H, which contained co-agents having high molecular weight (>500 daltons) and acrylate functionality ≥5, exhibited improved tear resistance over the EB-cured control at 7.5 Mrad, with Coagent D at 5% loading and Coagent H at 2% loading.

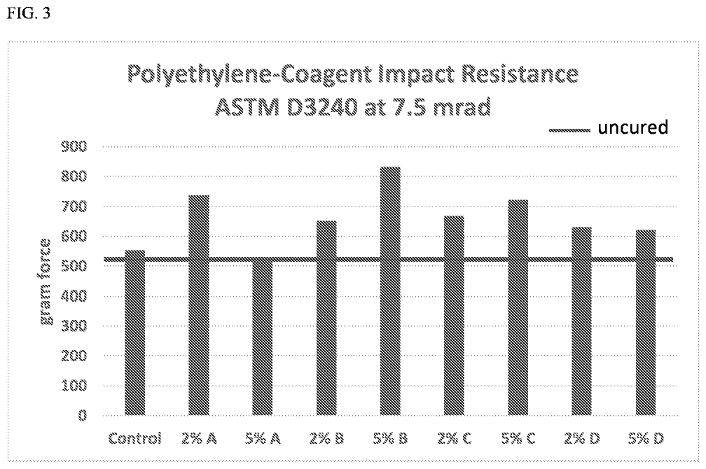

Additionally, LLDPE/Coagent films prepared using acrylate functional Coagents B and C at 5% loading exhibited improved Impact Resistance as compared to the EB-cured control films (FIG. 3).

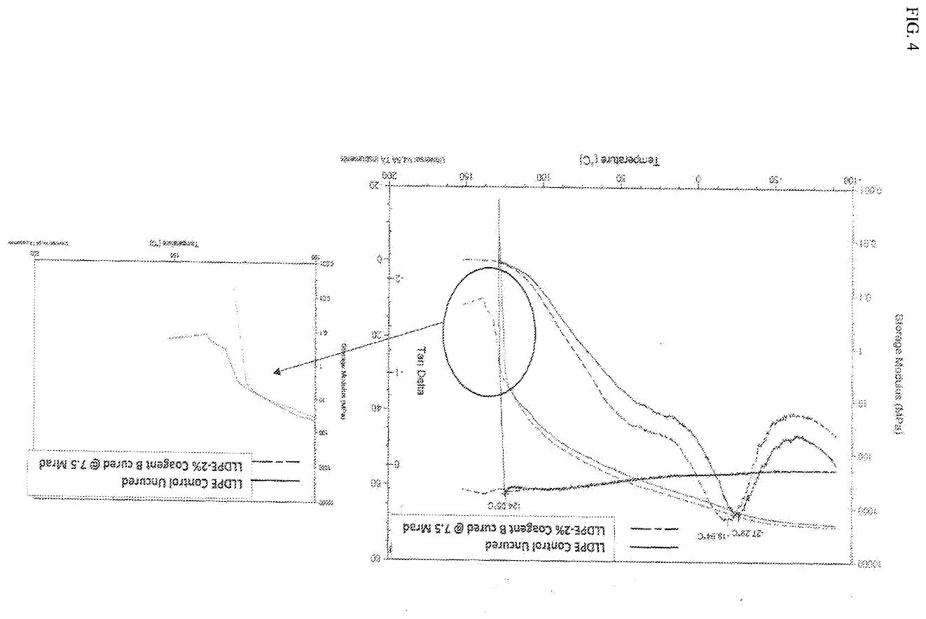

In another study (FIG. 4), the effect of Coagent B triacrylate monomer on the heat resistance of an LLDPE film was examined using Dynamic Mechanical Analysis (DMA). The LLDPE-2% Coagent B film exhibited a shift of 10% in the Loss Modulus Temperature as compared to the uncured LLDPE film and a plateau in the Storage Modulus that demonstrates crosslinking behavior.

1. A masterbatch composition comprised of:
a) at least one non-elastomeric thermoplastic polymer;
b) at least 5%, preferably at least 10%, by weight, based on the total weight of the masterbatch composition, of at least one multi(meth)acrylate-functionalized resin having at least two (meth)acrylate functional groups per molecule; and
c) when the at least one multi(meth)acrylate-functionalized resin has a (meth)acrylate equivalent weight below 500 daltons, at least one scorch retarder.

2. The masterbatch composition of claim 1, comprising at least 1 part by weight per 100 parts by weight of multi(meth)acrylate-functionalized resin of at least one scorch retarder.

3. The masterbatch composition of claim 1, wherein the at least one multi(meth)acrylate-functionalized resin includes at least one multi(meth)acrylate-functionalized resin meeting at least one of the following criteria:
i) at least five (meth)acrylate functional groups per molecule; or
ii) a number average molecular weight of at least 500 daltons.

4. The masterbatch composition of claim 1, wherein if a multi(meth)acrylate-functionalized resin is present which is an oligomer, the masterbatch composition does not comprise photoinitiator.

5. The masterbatch composition of claim 1, wherein the at least one non-elastomeric thermoplastic polymer includes at least one thermoplastic polymer selected from the group consisting of polyolefins, ethylene vinyl acetate copolymers, ethylene alkyl (meth)acrylate copolymers, and polyamides.

6. The masterbatch composition of claim 1, wherein the at least one non-elastomeric thermoplastic polymer includes at least one polyethylene.

7. The masterbatch composition of claim 1, wherein the masterbatch composition is comprised of from 10 to 40%, preferably from 10 to 20%, by weight, based on the total weight of the masterbatch composition, of the at least one multi(meth)acrylate-functionalized resin.

8. The masterbatch composition of claim 1, wherein the at least one multi(meth)acrylate-functionalized resin includes at least one multi(meth)acrylate-functionalized resin having five or more (meth)acrylate functional groups per molecule and a number average molecular weight of less than 500 daltons.

9. The masterbatch composition of claim 1, wherein the at least one multi(meth)acrylate-functionalized resin includes at least one multi(meth)acrylate-functionalized resin having three or more (meth)acrylate functional groups per molecule and a number average molecular weight of at least 500 daltons.

10. The masterbatch composition of claim 1, wherein the at least one multi(meth)acrylate-functionalized resin includes at least one multi(meth)acrylate-functionalized resin having a number average molecular weight of at least 500 daltons.

11. The masterbatch composition of claim 1, wherein the at least one multi(meth)acrylate-functionalized resin includes at least one multi(meth)acrylate-functionalized resin having a hydrocarbon core structure and a number average molecular weight of at least 500 daltons.

12. The masterbatch composition of claim 1, wherein the at least one multi(meth)acrylate-functionalized resin includes at least one multi(meth)acrylate-functionalized resin having a number average molecular weight of at least 1000 daltons.

13. The masterbatch composition of claim 1, wherein the at least one multi(meth)acrylate resin includes at least one multi(meth)acrylate-functionalized resin selected from the group consisting of dipentaerythritol pentaacrylate, di-trimethylolpropane tetraacrylate, 4EO pentaerythritol tetraacrylate, 3PO trimethylolpropane triacrylate, 6PO trimethylolpropane triacrylate, tris-hydroxyethyl isocyanurate triacrylate, trimethylolpropane triglycidyl ether triacrylate, polybutadiene diacrylate, and branched polyester acrylate oligomers having three or more acrylate functional groups per molecule.

14. The masterbatch composition of claim 1, wherein at least one scorch retarder is present and the at least one scorch retarder includes at least one scorch retarder selected from the group consisting of amino alkyl phenol scorch retarders, acid salts of amino alkyl phenol scorch retarders, tocopherol scorch retarders and combinations thereof.

15. Pellets comprised of the masterbatch composition of claim 1.

16. The pellets of claim 15, wherein the pellets are solid, dry and non-blocking.

17. A method of making a film, comprising combining the masterbatch composition of claim 1 with a second non-elastomeric thermoplastic polymer, which may be the same as or different from the first non-elastomeric thermoplastic polymer, to obtain a polymer composition and forming the polymer composition into a film.

18. A film comprised of:
a) at least one non-elastomeric thermoplastic polymer;
b) at least one multi(meth)acrylate-functionalized resin, wherein the at least one multi(meth)acrylate-functionalized resin meets at least one of the following criteria:
at least five (meth)acrylate functional groups per molecule; or
a number average molecular weight of at least 500 daltons; and
c) when the at least one multi(meth)acrylate-functionalized resin has a (meth)acrylate equivalent weight of less than 500 daltons, at least one scorch retarder.

19. A method for making a crosslinked film, wherein the method comprises exposing a film comprised of:
a) at least one non-elastomeric thermoplastic polymer;
b) at least one multi(meth)acrylate-functionalized resin, wherein the at least one multi(meth)acrylate-functionalized resin meets at least one of the following criteria:
at least five (meth)acrylate functional groups per molecule; or
a number average molecular weight of at least 500 daltons; and
c) when the at least one multi(meth)acrylate-functionalized resin has a (meth)acrylate equivalent weight of less than 500 daltons, at least one scorch retarder;
to an amount of ionizing radiation effective to crosslink the film.

20. A crosslinked film obtained by the method of claim 19.

21. A method of making a masterbatch composition wherein the masterbatch composition is provided in pellet form, comprising compounding at least one thermoplastic polymer, at least one multi(meth)acrylate-functionalized resin, and, optionally, at least one scorch retarder using either:
a) a twin-screw extruder and liquid injection delivery equipment having either a positive pressure diaphragm pump, peristaltic pump, or progressive cavity pump equipped with a strand die and an underwater pelletizer; or
b) a continuous mixer in-line with a single screw extruder, equipped with a strand die and an underwater pelletizer.

22. A method of making pellets of a masterbatch composition, wherein the method comprises:
a) feeding a thermoplastic polymer into an extruder having an extruder barrel, wherein the thermoplastic polymer is heated to a temperature effective to soften or melt the thermoplastic polymer;
b) mixing the thermoplastic polymer which is in softened or molten form in the extruder with a mixture of at least one multi(meth)acrylate-functionalized resin and at least one scorch retarder in liquid form or, if the at least one multi(meth)acrylate-functionalized resin is or are stable at the temperature at which the thermoplastic polymer is being compounded in the absence of scorch retarder, with multi(meth)acrylate-functionalized resin alone in liquid form, wherein the at least one multi(meth)acrylate-functionalized resin and optional at least one scorch retarder is or are optionally injected into the extruder through a vent or port in the extruder barrel, to obtain a compound;
c) extruding the compound through a die to form a strand; and
d) chopping the strand to form pellets comprised of the masterbatch composition.

23. A method of making pellets of a masterbatch composition, wherein the method comprises:
a) feeding a thermoplastic polymer to a continuous mixer, wherein the thermoplastic polymer is heated to a temperature effective to soften or melt the thermoplastic polymer;
b) mixing the thermoplastic polymer which is in softened or molten form in the continuous mixer with a liquid mixture comprised of at least one multi(meth)acrylate-functionalized resin and at least one scorch retarder or, if the at least one multi(meth)acrylate-functionalized resin is or are stable at the temperature at which the thermoplastic polymer is being compounded in the absence of scorch retarder, with multi(meth)acrylate-functionalized resin alone to obtain a compound;
c) transferring the compound to a feeder connected to a single-screw extruder:
d) extruding the compound through a die to form a strand; and
e) chopping the strand to form pellets comprised of the masterbatch composition.
